(19) United States
(12) Patent Application Publication
(10) Pub. No.: US 2008/0153516 A1
(43) Pub. Date: Jun. 26, 2008

(54) Visual Positioning System and Method for Mobile User Equipment

(75) Inventor: Kin-Hsing Hsieh, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/613,444

(22) Filed: Dec. 20, 2006

(51) Int. Cl. H04Q 7/20

(52) U.S. Cl. 455/456.6

(57) ABSTRACT

The disclosure provides a visual positioning system, server, and method for positioning a location of a mobile user equipment with camera. The method comprising receiving a still containing at least one visual cue, taken by camera of the mobile user equipment in the location; recognizing the visual cue contained in the still according to a database storing predetermined data sets of visual cues; and calculating the location according to the still and the data set of recognized visual cue. Each data set further comprising location, dimensions, and orientation of corresponding visual cue.

### BACKGROUND OF THE INVENTION

1. Field of the Invention

This invention is related to positioning, and particularly related to visual positioning for mobile user equipment.

2. Description of the Prior Art

Currently, mobile user equipment, such as smart phone and PDA, usually has of three functionalities, including photograph, telecommunication, and limited computing. Conventional mobile user equipment could have two kinds of positioning mechanism. The first independent approach is to attach a satellite positioning receiver to resolve the position of this user equipment independently. The second approach relies on the radio frequency triangulation of mobile user equipment performed by the value-added core network of base stations.

For the first approach, it requires additional antenna and dedicated processing module to resolve satellite signal. The volume of the additional antenna and dedicated processing module is a big burden for mobile user equipment. Moreover, due to the compact size of mobile user equipment, the transmitting bursts of telecommunication antenna would heavily influence the satellite receiver antenna nearby. In urban environment, the small satellite antenna could simultaneously track multiple signals hardly from various satellites. Reflecting and deflecting of multiple-path effect would serious downgrade the resolved precision degree and acquisition time of satellite signals. The most critical problem happened in the indoor environment, which requires extremely high signal-to-ratio for acquiring signal from multiple satellites.

For the second approach, an intelligence network (IN) architecture of the public land mobile network (PLMN) is required for this kind of positioning service, which is referred generally to location base service (LBS) in GSM/3GPP standards. Depending on the installed network topologies of base stations, LBS of IN could provide positions in various precision degree. A usual coarse grain position is defined in a grid of 100×100 meters. A fine grain position could be reported in a grid of 25×25 meters, which is comparable with precision degree of civil code of United States Global Position System. However, this LBS is closely tied to the PLMN since the triangulation of mobile user equipment RF signal demands accurate and synchronized reports from multiple base stations. Also, in urban environment, the triangulation also suffers from reflecting and deflecting of multiple-path effect.

Therefore it exist a need to have a precise positioning mechanism on mobile user equipment without additional antenna and dedicated processing module. Moreover, it also exist a need to have a precise positioning mechanism on mobile user equipment without dedicated PLMN support architecture.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The disclosure provides a visual positioning system, server, and method for positioning a location of a mobile user equipment with camera in order prevent the drawbacks described above.

In one embodiment, a visual positioning system for positioning a location of a mobile user equipment with camera is provided. The system comprises a plurality of visual cues and a positioning server. Each visual cue has a predetermined data set, each data set further comprising location, dimensions, and orientation of corresponding visual cue. The positioning server is configured to receive at least one still, containing at least one visual cue, shot by the mobile user equipment for reporting the location. It further comprises a database is configured to store the data sets of the plurality of visual cues; a recognition unit is configured to recognize and identify the visual cue contained in the still according to the data sets stored in the database; and a calculation unit is configured to calculate the location of the mobile user equipment according to the data set of the recognized visual cue by the recognition unit.

In one embodiment, a positioning server for positioning a location of a mobile user equipment with camera is disclosed. The server comprises a database, a recognition unit, and a calculation unit. The database is configured to store data sets of a plurality of visual cues. Each visual cue has predetermined data set, each data set further comprising location, dimensions, and orientation of corresponding visual cue. The recognition unit is configured to recognize and identify the visual cue contained in a received still according to the data sets stored in the database. The received still is shot by the mobile user equipment for reporting the location. The calculation unit is configured to calculate the location of the mobile user equipment according to the data set of the recognized visual cue by the recognition unit.

In one embodiment, a visual positioning method for positioning a location of a mobile user equipment with camera is provided. The method comprising receiving a still containing at least one visual cue, taken by camera of the mobile user equipment in the location; recognizing the visual cue contained in the still according to a database storing predetermined data sets of visual cues; and calculating the location according to the still and the data set of recognized visual cue. Each data set further comprising location, dimensions, and orientation of corresponding visual cue.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram shows a conventional method for calculating distance and viewing angle;

FIG. 2 is a block diagram depicts a visual positioning system in accordance with an embodiment of the present invention;

FIG. 3 is a flowchart diagram of a processing iteration in accordance with an embodiment of the present invention; and

FIG. 4 is a complete flowchart diagram in accordance with one embodiment of the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

Digital camera is becoming a basic integrating part of mobile user equipment. In recent two years, the pixel element number of digital camera embedded mainstream mobile user equipment sky rockets from less than 300 thousands to more than 2 million. Besides, most of the embedded cameras feature with electronic automatic focusing capability and a few ones feature with mechanical automatic focusing function. The photographing information such as diaphragm, shutter speed, lens, and etc could be electronically reported and documented with the file. For example, Exchangeable Image File Format (EXIF) is an industrial standard which is a part of the Design rule for Camera File (DCF) standard created by Japan Electronics and Information Technology Industries Association (JEITA) to encourage interoperability between imaging devices, implemented by various vendors, for reporting such photographing information. In addition to shot still photo, the embedded of digital camera subsystem is also capable for recoding video slice in popular formats such as .3GP and .MP4. Since the photographing subsystem is integrated to the whole mobile user equipment, the still or video slice could be recorded and processed by the mobile user equipment. Moreover, the still or video slice could also be delivered to other computing devices attached to the PLMN via some communication protocols such as multimedia message service (MMS) and/or GPRS.

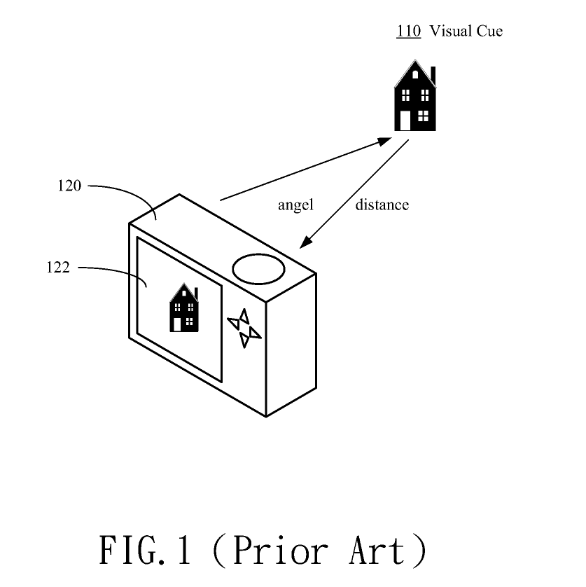

Please refer to FIG. 1 which is a diagram shows a conventional method for calculating distance and viewing angle. For a given visual cue 110, a still 122 and/or a video slice 124 of this visual cue 110 could tell the distance and viewing angle between the visual cue 110 and the still camera 120 if the lens information is known as well as the dimension, shape, and orientation of the visual cue 110.

Ordinary in the skill could easily understand that a plurality of still 122 could be extracted from the video slice 124 in various time frames. Usually the video slice recorded is compressed, depending on the format of the video slice 124, how to choose appropriate stills 122 from a video slice is not concerned in this disclosure.

Furthermore, the image processing technologies for retrieving information in the still 122 could be categorized into three levels. The easiest level is usually referred as Optical Character Recognition (OCR), the second level is more complicated as pattern recognition from a plain image, and the third level involves three dimensional object recognition and modeling from time diversity image information. Ordinary in the skill could easily understand that all of these technologies could be used to distill information from the still 122 or the video slice 124.

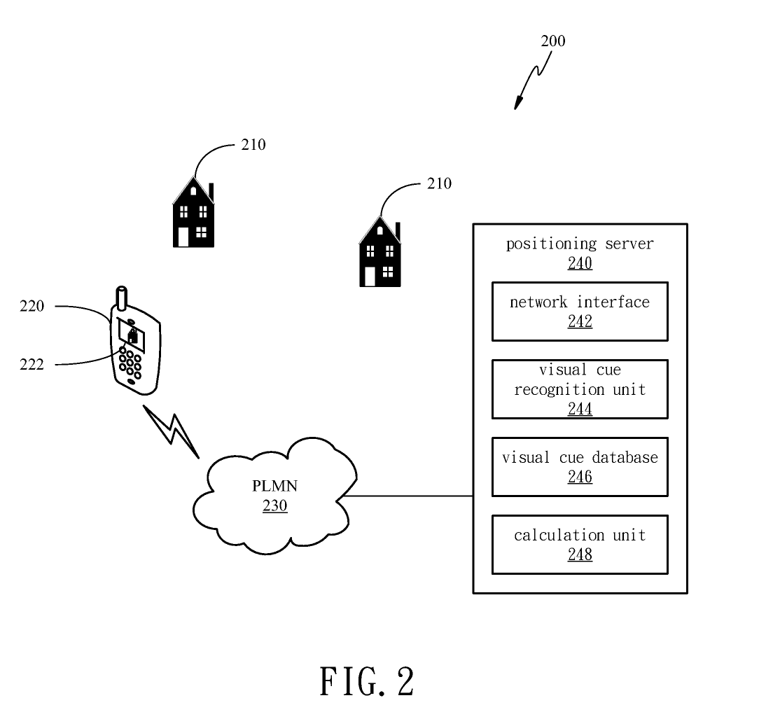

Please refer to FIG. 2, which is a visual positioning system 200 in accordance with an embodiment of the present invention. The visual positioning system 200 comprises at least one known visual cue 210, a mobile user equipment 220, a PLMN 230, and a positioning server 240. For each visual cue 210, there would be an associated physical data set stored in the positioning server 240. The associated data set may include the dimension, shape, and orientation of the visual cue 210 itself and the exact location of the installed site, such as elevation, longitude, and latitude. The positioning data of the visual cue 210 is relevant to the coordination system embodied in this visual positioning system 200. In one embodiment, the coordination system may be a GPS coordination system. Ordinary in the skill could easily understand the mapping between different geographical coordination systems is well-known and not included in this disclosure.

In this system 200, the dimensions, shape, and orientation of each visual cue 210 could be different to help identification more easily. The visual cue 210 may be made and installed purposely in one embodiment. Or the well-known landmark may be taken as the visual cue 210 in another embodiment. In an urban environment, a big and tall landmark such as Eiffel Tower in Paris and Twin Towers in Kuala Lumpur with enormous visual range is quite suitable for being taken as visual cue 210. However, for some landmarks with symmetric shape, such as Taipei 101 building, they are restricted for calculating the distance only between the landmark and the mobile user equipment 220.

In one embodiment, the associated data set may also include the lighting patterns of the corresponding visual cue 210 in the various lighting conditions. For example, the illumination provided by the famous landmarks in the night is very different to the appearance in the day time. Dealing with the lighting patterns could help to improve the correct recognition rate as well as the precision of the estimated range and angle of the visual cue 210.

With a digital camera 222, the mobile user equipment 220 is attached to the PLMN 230 such that the mobile user equipment 220 is communicative with the positioning server 240. In one embodiment, the interconnection channel between the mobile user equipment 220 and the positioning server 240 may be but not restricted to SMS, MMS or GPRS such that the mobile user equipment 220 could send the still or motion slice as well as the photographing to the positioning server 240. Furthermore, as long as the positioning server 240 could be reachable by the mobile user equipment 220, the invention does not have to include the PLMN 230. In this disclosure, the PLMN 230 may be implemented but not restricted to GSM, EDGE, WCDMA, CDMA, CDMA2000, Terrestrial Trunked Radio (TETRA), or any other trunked radio network.

The positioning server 240 may comprises a network interface 242, a visual cue recognition unit 244, a visual cue database 246, and a calculation unit 248. The network interface 242 is configured to connect at least one PLMN 230 to be communicative with the mobile user equipment 220. The visual cue recognition unit 244 is configured to retrieve the imaged visual cue from the received still or motion slice sent by the mobile user equipment 220. The visual cue database 246 is configured to store the data sets of every visual cue 210 in this system 200. At last, the calculation unit 248 is configured to calculate the position of the mobile user equipment 220 according to the visual cue data sets provided by the visual cue database 244 and the photographing information provided by the mobile user equipment 220.

In one embodiment, depending on the specifications or standard of the PLMN 230 attached to the positioning server 240, the PLMN 230 may provide further information including but not restricted to identity of mobile user equipment 220, telephone number, identity of the user, identity of the PLMN 230 itself, and even the identities of the base stations communicating with the mobile user equipment 220. The positioning server 240 may use the information to help the positioning of the mobile user equipment 220.

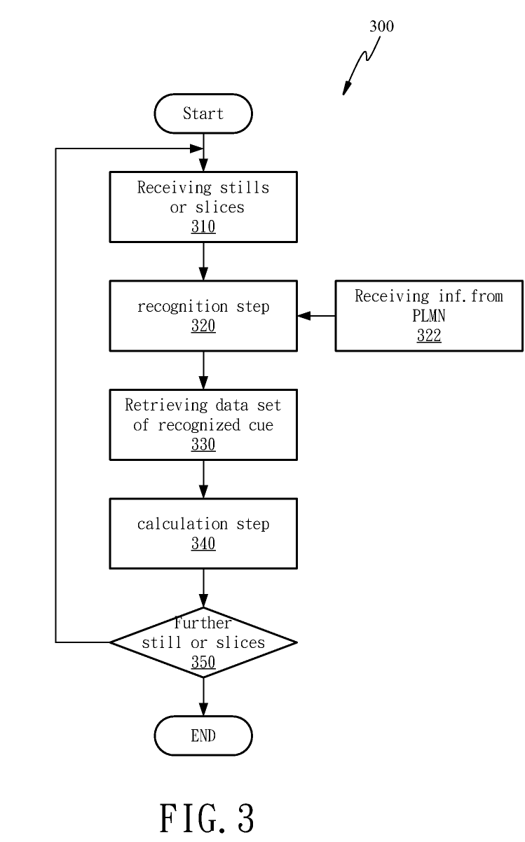

Please refer to FIG. 3, which is one iteration 300 of a flowchart diagram in accordance with an embodiment of the present invention. In a first step 310, the positioning server 240 receives at least one imaged visual cue still or motion slice with its photographing information from the mobile user equipment 220 via the network interface 242 and the PLMN 230. Next, the imaged visual cue is recognized from the still or motion slice by the visual cue recognition unit 244 in recognition step 320. In the optional step 322, since the recognition step 320 takes quite a lot of comparisons, the network interface 242 may inform the visual cue recognition unit 244 with the information provided by the PLMN 230 for limiting the search range of visual cues 210. Once the imaged visual cue is identified by the recognition unit 242, the corresponding data set of the recognized visual cue 210 would be provided by the database 244 to the calculation unit 246 in the subsequent step 330. Combining the data set with the photographing information, the calculation unit 248 could tell an estimated position in the calculation step 340. In the following determination step 350, any further still or slices required to process is determined. In one embodiment, the step 350 further comprises a location precision analysis. If the required precision is achieved by previous iterations, the flowchart goes to end; otherwise, it looped back to the first step 310.

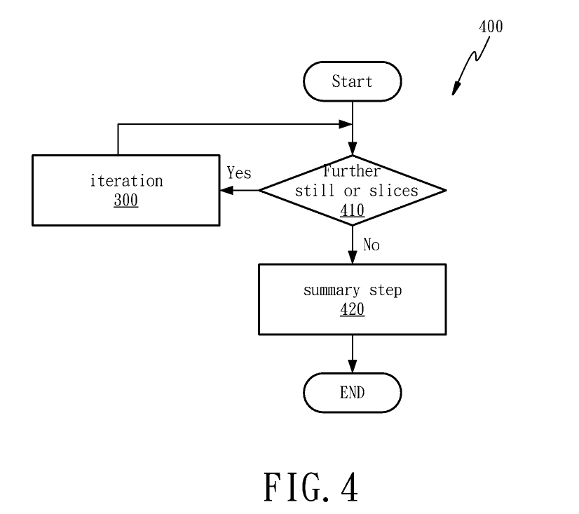

Please refer to FIG. 4, which is a complete flowchart in accordance with one embodiment of the present invention. In a first step 410, the positioning server 240 checks whether there is un-calculated visual cue still or motion slice shot by the digital camera 222 of the mobile user equipment 220 in the same position. If so, the flow goes to run the iteration 300 shown in the FIG. 3 to get an estimated position. Otherwise, the flow will go to a summary step 420 to average all estimated positions from all imaged visual cue still or motion slices to get a best estimation one. In this flow 400, each iteration 300 is counting on still or motion slice shooting at different visual cue 210.

In one embodiment, the mobile user equipment 220 may embody another mobile visual cue recognition unit 224 for identify the visual cue 210 during the preview process in or near real-time. Moreover, the mobile visual cue recognition unit 224 could reach the database 246 to retrieve visual cue data sets for recognition. In another alternative, the mobile visual cue recognition unit 224 could cache or store some or all visual cue data sets in the database 246 for recognition. During the preview process in or near real-time, the photographing subsystem may indicate whether at least one visual cue 210 appear in the preview window or display by the mobile visual cue recognition unit 224.

In one embodiment, since the position could be recorded with time, a motion speed or rate of the mobile user equipment 220 could be calculated by itself or positioning server 240.

In one embodiment, the system 200 may comprise one authentication-authorization-accounting (AAA) server coupled to the positioning server 240 and/or the PLMN 230 for providing the authentication, authorization, and accounting functionalities.

In one embodiment, the system 200 may further comprise an interception module 250 for intercepting any still or video slice transported from the mobile user equipment 220 via wireless or wired communication. The intercepted stills or video slices are sent to the positioning system 240 by the interception module 250. In another embodiment, the interception module 250 could be installed in the PLMN 230 for intercepting any still or video slice communicating between the mobile user equipment 220 and the PLMN 230.

In one embodiment, the visual cue 210 may comprise human-readable or machine readable codes. For example, an insignia, a registered trademark, a logo, or words may be also recognized by the positioning server 240. Once the human-readable or machine readable codes are decoded or comprehended, it is more easily to help limiting the search range of visual cues 210.

Since the positioning server 240 could be independent to the PLMN 230, the visual positioning system 200 could be free of the restrictions of conventional LBS provided by the intelligent network. Moreover, the conventional mobile user equipment 220, such as smart phone and PDA, could be used in this system 200 without additional hardware and software to resolve satellite signals.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A visual positioning system for positioning a location of a mobile user equipment with camera, comprising:
a plurality of visual cues, wherein each visual cue has a predetermined data set, each data set further comprising location, dimensions, and orientation of corresponding visual cue; and
a positioning server is configured to receive at least one still, containing at least one visual cue, shot by the mobile user equipment for reporting the location, wherein the positioning server further comprising:
a database is configured to store the data sets of the plurality of visual cues;
a recognition unit is configured to recognize and identify the visual cue contained in the still according to the data sets stored in the database; and
a calculation unit is configured to calculate the location of the mobile user equipment according to the data set of the recognized visual cue by the recognition unit.

2. The visual positioning system of claim 1, wherein the positioning server further comprising a network interface for connecting to a radio network, the mobile user equipment attached, and receiving the still from the mobile user equipment.

3. The visual positioning system of claim 2, wherein the positioning server further receives information provided by the radio network for reducing the searching on the data sets in the database, wherein the information being a combination selected from a group of:
identity of the mobile user equipment;
telephone number of the mobile user equipment;
user identity of the mobile user equipment;
identity of the radio network; and
identity of the base station, communicating with the mobile user equipment, of the radio network.

4. The visual positioning system of claim 1, wherein the calculation unit further calculate the location from more than one still shot in the same place for improving the preciseness of the location, wherein each still shot containing different visual cue.

5. The visual positioning system of claim 1, further comprising:
a authentication-authorization-accounting server, coupled to the positioning server, for providing authentication, authorization, and accounting of the user.

6. The visual positioning system of claim 1, further comprising:
an interception module is configured to intercept any still or video slice transported from the mobile user equipment and to send the intercepted still or video slice to the positioning server.

7. The visual positioning system of claim 1, wherein the still comprising photographing information for the calculation unit.

8. A positioning server for positioning a location of a mobile user equipment with camera, comprising:
a database is configured to store data sets of a plurality of visual cues, wherein each visual cue has predetermined data set, each data set further comprising location, dimensions, and orientation of corresponding visual cue;
a recognition unit is configured to recognize and identify the visual cue contained in a received still according to the data sets stored in the database, wherein the received still is shot by the mobile user equipment for reporting the location; and
a calculation unit is configured to calculate the location of the mobile user equipment according to the data set of the recognized visual cue by the recognition unit.

9. The positioning server of claim 8, further comprising a network interface for connecting to a radio network, the mobile user equipment attached, and receiving the still from the mobile user equipment.

10. The positioning server of claim 9, further receives information provided by the radio network for reducing the searching on the data sets in the database, wherein the information being a combination selected from a group of:
identity of the mobile user equipment;
telephone number of the mobile user equipment;
user identity of the mobile user equipment;
identity of the radio network; and
identity of the base station, communicating with the mobile user equipment, of the radio network.

11. The positioning server of claim 8, wherein the calculation unit further calculate location from more than one still shot in the same place for improving the preciseness of the location, wherein each still shot containing different visual cue.

12. The positioning server of claim 9, wherein the radio network further comprising:
an interception module is configured to intercept any still or video slice transported from the mobile user equipment and to send the intercepted still or video slice to the positioning server.

13. The positioning server of claim 8, wherein the recognition unit is further configured to recognize human-readable or machine readable codes of the visual cues.

14. The positioning server of claim 13, wherein the still comprising photographing information for the calculation unit.

15. A visual positioning method for positioning a location of a mobile user equipment with camera, comprising:
receiving a still containing at least one visual cue, taken by camera of the mobile user equipment in the location;
recognizing the visual cue contained in the still according to a database storing predetermined data sets of visual cues, wherein each data set further comprising location, dimensions, and orientation of corresponding visual cue;
calculating the location according to the still and the data set of recognized visual cue.

16. The visual positioning method of claim 15, further comprising receiving information provided by the radio network for reducing the searching on the data sets in the database, wherein the information being a combination selected from a group of:
identity of the mobile user equipment;
telephone number of the mobile user equipment;
user identity of the mobile user equipment;
identity of the radio network; and
identity of the base station, communicating with the mobile user equipment, of the radio network.

17. The visual positioning method of claim 15, further comprising calculating the location from more than one still shot in the same place for improving the preciseness of the location, wherein each still shot containing different visual cue.

18. The visual positioning method of claim 15, further comprising:
intercepting any still or video slice transported from the mobile user equipment.

19. The visual positioning method of claim 15, further comprising:
recognizing human-readable or machine readable codes of the visual cues.

20. The visual positioning method of claim 15, wherein the still comprising photographing information for the calculating.
